(19) United States
(12) Patent Application Publication
(10) Pub. No.: US 2022/0324250 A1
(43) Pub. Date: Oct. 13, 2022

(54) WRITING IMPLEMENT

(71) Applicant: MITSUBISHI PENCIL COMPANY, LIMITED, Shinagawa-ku (JP)

(72) Inventors: Hirotake IZAWA, Shinagawa-ku (JP); Toshimi KAMITANI, Shinagawa-ku (JP)

(73) Assignee: MITSUBISHI PENCIL COMPANY, LIMITED, Shinagawa-ku (JP)

(21) Appl. No.: 17/633,751

(22) PCT Filed: Aug. 3, 2020
(86) PCT No.: PCT/JP2020/029695

§ 371 Date: Feb. 8, 2022

(30) Foreign Application Priority Data
Aug. 9, 2019 (JP) 2019-147746
May 14, 2020 (JP) 2020-085294

(51) Int. Cl. B43K 8/02; B43K 1/12; B43K 27/08

(52) U.S. Cl. CPC B43K 8/02; B43K 1/12; B43K 27/08

(57) ABSTRACT

Provided is a writing implement having a pen tip with a viewer part where the effective area for allowing visual recognition of the writing direction relative to the entire pen tip is maximized without impairing ink discharge. The pen tip feeds ink from the writing implement body, and the writing direction can be recognized through the viewer part. The pen tip has a holding body with the viewer part and a writing part that attaches a writing core having a U-shaped or L-shaped configuration to the holding body. The part of the writing core in contact with the side surface of the holding body is formed to have a square cross-section.

### TECHNICAL FIELD

The present description relates to a writing implement having a pen tip that allows visual recognition of the writing direction. More specifically, the present invention relates to a writing implement having a pen tip in which the effective area of a viewer part allowing visual recognition of the writing direction relative to the whole pen tip is maximized without impairing ink discharge.

### BACKGROUND ART

Conventionally, pen tips of writing implements, which are conventionally called paint markers, underline markers, and the like, have a wide pen core for enabling wide line drawing, and have been widely used because of excellency in usability and the visibility of marking.

The pen tip of a writing implement such as a highlight marker is generally formed of a rod-like bundle of synthetic resin fibers or a porous material such as a polymer sintered body, and is given with capillarity so that ink supplied from the barrel body, i.e., the main body of the writing implement, is fed to the pen tip to enable drawing.

With the spread of writing implements containing fluorescent ink in the barrel body that serves as the writing implement body, writing implements having various pen tip of the shapes and the structures that enable wide line drawing have been put on the market. It offers users a wide selection of writing implements according to their usage, bringing comfortable use.

The applicant of the present invention has disclosed a writing implement including a pen tip that can lead and retain ink supplied from an ink absorbent body (sliver) in a barrel body serving as a writing implement body, the pen tip being equipped with a viewer part (see-through part) that allows visual recognition of the writing direction (e.g., see Patent Document 1).

Since the pen tip of this type of writing implement allows visual recognition of the writing part, it is possible to stop drawing a line at an exact point where the user wants to stop, and hence prevent the line from being drawn excessively or overshot.

However, the pen tip of the above Patent Document 1 has a shape in which the ink feeder and the writing part are integrated, and is formed of a sintered body obtained by sintering particles of thermoplastic resin such as polyethylene in a complicated shape, so that it needs to feed ink from the ink absorbent body as far as the length of the holding body. For this reason, the ink feeder needs to have a thick design, which, however, blocks the viewer part with the thick ink feeder, causing a problem, i.e., reduction of the effective area of the viewer part with respect to the whole of the pen tip.

On the other hand, as the prior art of pen tips having a viewer part allowing visual recognition of the writing direction other than the above-described structure, the present applicant has proposed some constitutions as follows, for example:

1) a writing implement, having a pen tip which includes a porous body serving as the writing part, an ink feed core for holding the porous body and supplying ink to the writing part, and a holding body that has the ink feed core therein and serves as a viewer part for allowing visual recognition of the writing direction, characterized in that at least one groove part for making the ink feed core appear thin is formed on the outer surface of the holding body (see, for example, Patent Document 2);

2) a writing implement, having a pen tip which includes a porous body serving as the writing part, a holding body that holds the porous body and has at least one ink feeder for supplying ink to the writing part; a relay porous body for supplying the ink in the writing implement main body to the ink feeder provided in the holding body, the holding body serving as a viewer part for allowing visual recognition of the writing direction, characterized in that the ink feeder is arranged in the approximate center, and has an ink feed core impregnated with ink therein (see, for example, Patent Document 3); and,

3) a writing implement, having a barrel cylinder containing writing ink and a writing part fitted on one end of the barrel cylinder, characterized in that the writing part has a writing body that feeds the writing ink from the barrel cylinder and enables writing with the writing ink, and a holding body for holding the writing body, wherein the holding body is formed of a hard material having visible recognition and provided with the writing body such that when the holding body is viewed from a particular angle, the appearing area of the writing body in the surface area of the holding body is equal to 50% or lower (see, for example, Patent Document 4).

Though the pen tips described in Patent Documents 2 to 4 can offer a wider range of view of the writing surface through the pen tip as compared to the prior art Patent Document 1, the area of the viewer part allowing visual recognition of the writing direction relative the whole of the pent tip has not yet to be maximized at present, so further improvement has been desired.

### PRIOR ART DOCUMENTS

### Patent Documents

### Patent Document 1:

Japanese Patent Application Laid-Open No. 2000-52682 (claims, FIG. 1, etc.)

### Patent Document 2:

Japanese Patent Application Laid-Open No. 2018-118420 (claims, FIG. 4, etc.)

### Patent Document 3:

Japanese Patent Application Laid-Open No. 2014-50970 (claims, FIG. 1, etc.)

### Patent Document 4:

Japanese Patent Application Laid-Open No. 2018-30293 (claims, FIG. 4, etc.)

### SUMMARY OF THE INVENTION

### Problems to be Solved by the Invention

The present disclosure has been devised in view of the above-described problems of the prior art and is intended to solve the problems. It is an object of the present disclosure to provide, in a writing implement having a pen tip allowing visual recognition of the writing direction, a writing implement having a pen tip in which the effective area of a viewer part allowing visual recognition of the writing direction relative to the entire pen tip is maximized while the discharge of ink is secured.

### Means for Solving the Problems

The inventors have earnestly studied in order to solve the problems of the prior art and found a writing implement sufficing the above object by providing a writing implement comprising a pen tip that feeds ink from a writing implement body and has a viewer part through which the writing direction can be recognized, with a specific configuration in the above pen tip, and completed the present disclosure.

Specifically, the writing implement of the present disclosure is a writing implement equipped with a pen tip that feeds ink from a writing implement body and has a viewer part through which the writing direction can be recognized, having at least a holding body having the viewer part and a writing part having a writing core of U-shaped or L-shaped configuration attached to the holding body, characterized in that a part of the writing core in contact with a side surface of the holding body is formed to have a square cross-section.

It is preferable that a front end part of the holding body is formed in a refracting facet.

It is preferable that the surface of the holding body with which the writing core is in contact is formed with ribs that extend in the direction perpendicular to the axis.

It is preferable that the aspect ratio of the cross-section of the supplying part in the writing core is 1:1.2 or greater.

It is preferable that the front barrel that fixes the pen tip covers at least a part of the outer circumference of the writing core.

### Effect of the Invention

According to the present disclosure, provided is a writing implement maximizing the effective area of a viewer part allowing visual recognition of the writing direction relative to the whole pen tip without impairing ink discharge.

In the present specification, both the general description described above and the detailed description described below are exemplary and descriptive, and do not limit the present invention described in the claims.

### BRIEF DESCRIPTION OF DRAWINGS

FIG. 1 Drawings showing a writing implement of a first embodiment of the present disclosure, (a) a plan view, (b) a front view, and (c) a vertical section seen from the front.

FIG. 2 Enlarged perspective drawings showing the pen tip of FIG. 1, (a) an enlarged perspective view of the pen tip viewed from one direction, and (b) an enlarged perspective view of the pen tip viewed from the direction 180° rotated from (a).

FIG. 3 Drawings showing an example of a pen tip used for the writing implement of FIG. 1, (a) a plan view, (b) a front view, (c) a vertical section of the front view, (d) a bottom view,(e) a perspective view seen from the front side, (f) a perspective view seen from the rear side, (g) a left side view, (h) a sectional view taken along a line X-X in (b), and (i) a right side view.

FIG. 4 Drawings showing an example of a holding body in a pen tip used for the writing implement of FIG. 1, (a) a plan view, (b) a front view, (c) a vertical section seen from the front, (d) a bottom view, (e) a perspective view seen from the front side, (f) a left side view, (g) a sectional view taken along a line Y-Y in (f), (h) a right side view, and (i) a perspective view of the bottom side as viewed from the rear side.

FIG. 5 Drawings showing a writing implement according to a second embodiment of the present disclosure, (a) a plan view, (b) a front view, and (c) a vertical section seen from the front.

FIG. 6 Enlarged perspective drawings showing the pen tip of FIG. 5, (a) an enlarged perspective view of the pen tip viewed from one direction, and (b) an enlarged perspective view of the pen tip viewed from the direction 180° rotated from (a).

FIG. 7 Drawings showing an example of a pen tip used for the writing implement of FIG. 5, (a) a plan view, (b) a front view, (c) a vertical section of the front view, (d) a bottom view, (e) a perspective view seen from the front side, (f) a perspective view seen from the rear side, (g) a left side view, (h) a sectional view taken along a line Z-Z in (b), and (i) a right side view.

FIG. 8 Drawings showing an example of a holding body in a pen tip used for the writing implement of FIG. 5, (a) a plan view, (b) a front view, (c) a vertical section seen from the front, (d) a bottom view, (e) a perspective view seen from the front side, (f) a left side view, (g) a sectional view taken along a line V-V in (f), (h) a right side view, and (i) a perspective view of the bottom side as viewed from the rear side.

FIG. 9(a) and (b), each enlarged partial side views showing the states in which the writing implements of the first embodiment and the second embodiment are tilted for writing.

FIG. 10 Drawings showing a writing implement of a third embodiment of the present disclosure, (a) a front view, (b) a vertical section, and (c) an enlarged partial vertical section of a pen tip.

FIG. 11 An enlarged perspective drawing of the pen tip of FIG. 10.

FIG. 12 Drawings showing an example of a pen tip used for the writing implement of FIG. 10, (a) a plan view, (b) a left side view, (c) a front view, (d) a right side view, and (e) a vertical section seen from the front.

FIG. 13 Drawings showing an example of a holding body in a pen tip used for the writing implement of FIG. 10, (a) a perspective view seen from the front side, (b) a perspective view seen from the rear side, (c) a plan view, (d) a left side view, (e) a front view, (f) a right side view, and (g) a vertical section seen from the front.

FIG. 14 Drawings showing an example of a front barrel in a pen tip used for the writing implement of FIG. 10, (a) a plan view, (b) a perspective view seen from the upper front side, (c) a left side view, (d) a front view, (e) a right side view, (f) a vertical section seen from the front, (g) to (i), and sectional views taken along lines G-G, H-H, and I-I, respectively.

FIG. 15 Drawings showing an example of a writing core in a pen tip used for the writing implement of FIG. 10, (a) a perspective view seen from the front side, (b) a perspective view seen from the rear side, (c) a plan view, (d) a left side view, (e) a front view, (f) a right side view, (g) a vertical section seen from the front, and (h) a cross-section of a thin-plate piece (sheet piece) part.

FIG. 16 Drawings showing the writing core shown in FIG. 15 before assembly, (a) a plan view, (b) a front view, and (c) a vertical section seen from the front.

FIG. 17 An enlarged partial side drawing showing a state in which a writing implement of a third embodiment is tilted for writing.

### MODE FOR CARRYING OUT THE INVENTION

Hereinafter, at least some embodiments of the present invention will be described in detail with reference to the drawings. However, it should be noted that the technical scope of the present invention is not limited to each of the embodiments detailed below, and refers to the inventions described in the claims and their equivalents.

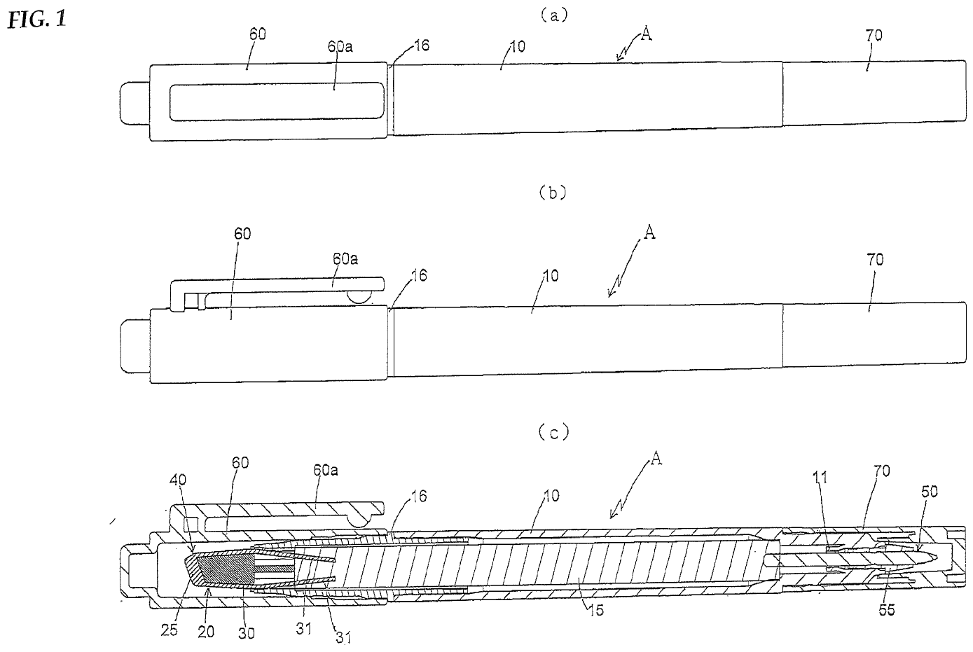

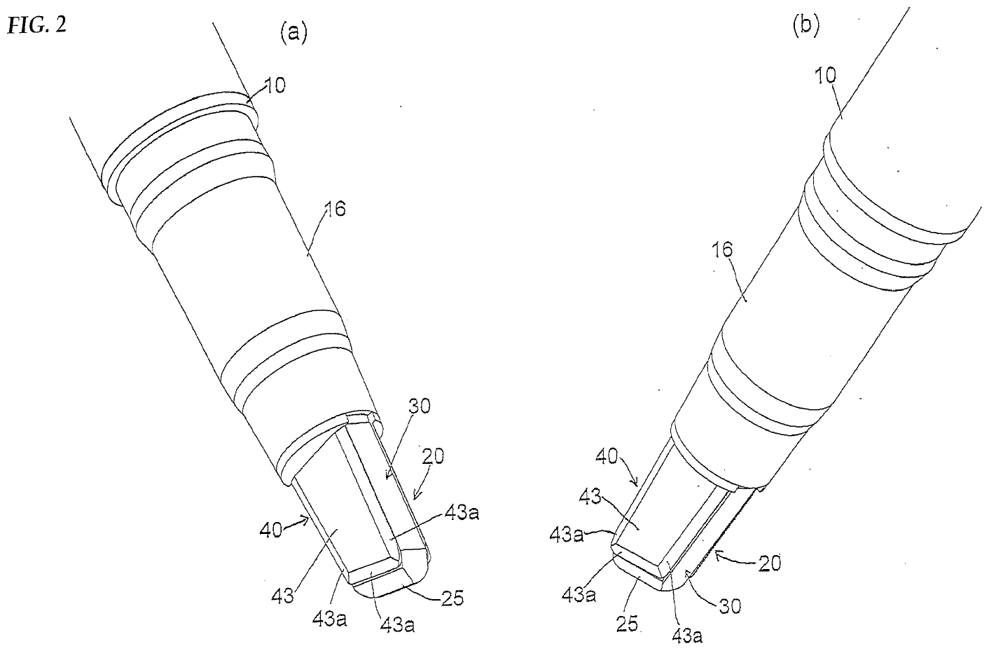

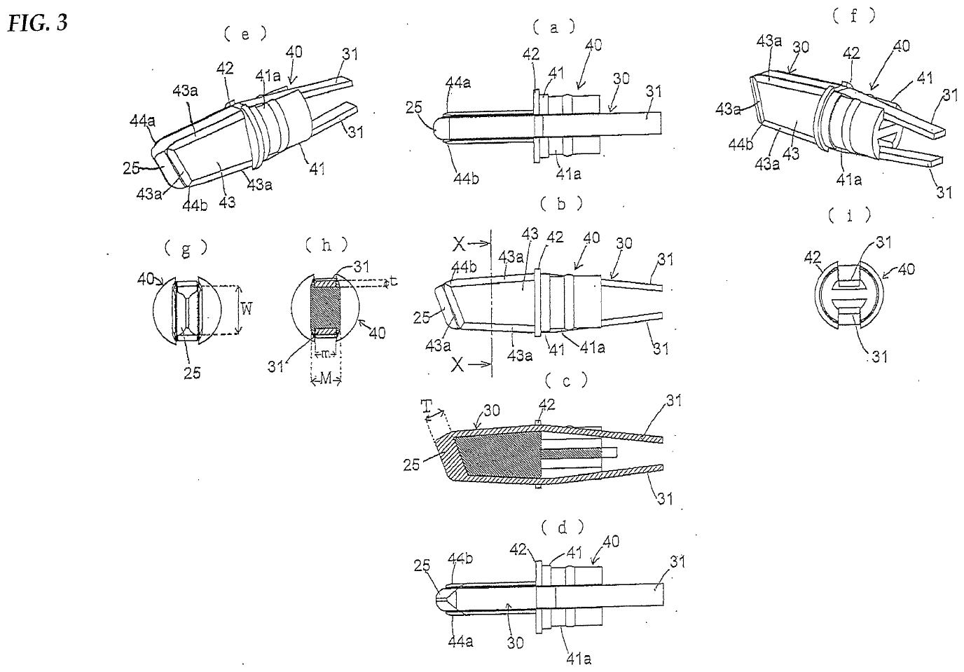

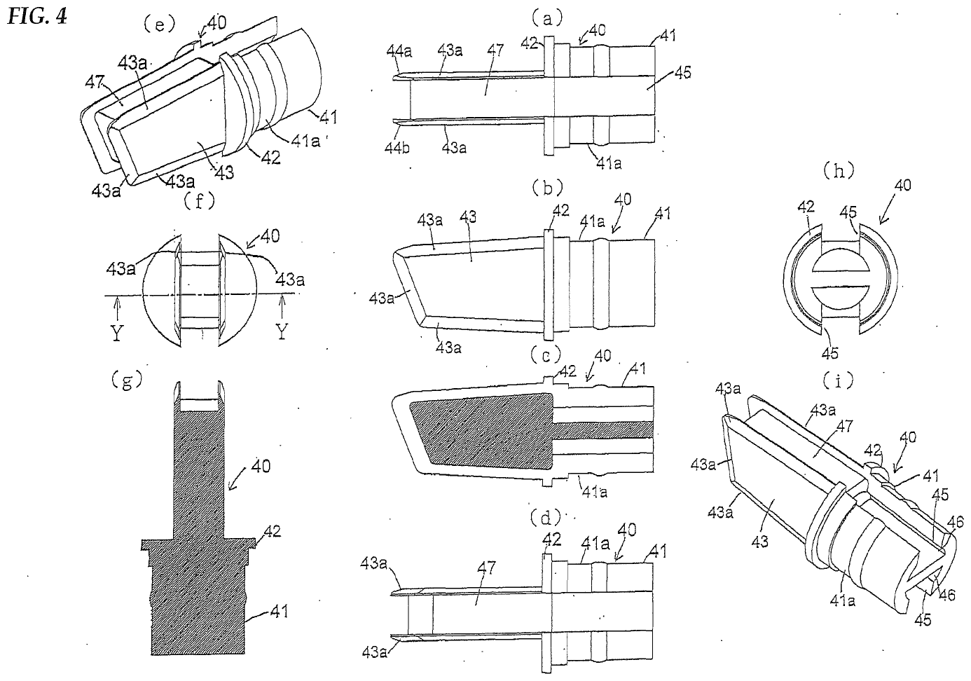

FIGS. 1 to 4 show writing implements of a first embodiment of the disclosure, and are each drawings of a twin-type writing implement having two types of pen tips. FIG. 2 is enlarged perspective views of a pen tip used for the writing implement of FIG. 1, viewed from different directions. FIGS. 3 and 4 are drawings of parts forming the pen tip, such as a writing core and a holding body.

A writing implement A of the present embodiment is, as shown in FIGS. 1 (a) to 1(c), a twin-type writing implement that has a pen tip 20 feeding ink from a writing implement body (barrel cylinder) 10 and having a viewer part through which the writing direction can be viewed, and a rod-shaped pen tip 50 made of polyacetal on the opposite side of the pen tip 20. Removably attached on both sides of the writing implement body 10 are a cap 60 having a clip 60a for protecting the pen tip 20 and a cap 70 for protecting the pen tip 50.

The writing implement body 10 is a cylindrical body which is made of, for example, a thermoplastic resin, a thermosetting resin, or the like, and contains an ink absorbent body 15 impregnated with an ink for writing implements, with a holder 11 having a fitting part for fixing a holding piece 55 for holding the rod-shaped pen tip 50 of a fine type, arranged at one end on the right side in the drawing while a front barrel 16 fixing the pen tip 20 having the viewer part through which the writing direction can be seen, attached at the other end on the left side.

The writing implement body 10 is a cylindrical molding formed of a resin such as polypropylene or the like, and serves as a writing implement main body (barrel body). The writing implement body 10 is molded opaque or transparent (and translucent), but either may be adopted in view of appearance and practical use.

The ink absorbent body 15 is impregnated with an ink for writing implements such as water-based ink and oil-based ink, and the examples may include fiber bundles formed of one of, or a combination of two or more of, natural fiber, animal fur fiber, polyacetal resin, acrylic resin, polyester resin, polyamide resin, polyurethane resin, polyolefin resin, polyvinyl resin, polycarbonate resin, polyether resin, polyphenylene resin, etc., a processed material of fiber bundles such as felt etc., and/or porous materials such as sponges, resin particles, and sintered bodies. The ink absorbent body 15 is accommodated and held in the writing implement body 10.

The composition of the ink for writing implements to be used is not particularly limited, and may be suitably formulated as a compound of an aqueous ink, an oil-based ink, or a thermochromic ink, depending on the application of the writing implement; for example, for underliner pens and the like, fluorescent dyes such as Basic Violet 11, Basic Yellow 40, thermochromic microcapsule pigments, and the like can be formulated as content.

It is preferable that the ink is formulated by adjusting the kinds of ink ingredients and the compound ratio so as to present an ink viscosity (25° C.: cone/plate viscometer) of 1 to 5 mPa·s, a surface tension of 30 to 60 mN/m, an ink outflow X from the pen tip 20 of 5 to 20 mg/m, and an ink outflow Y from the pen tip 50 of 0.1 to 5 mg/m, while Setting X greater than Y, because it enables easy change of different ways of writing. The ink outflow is measured by setting the pen on an automatic writing device and writing on high-quality paper at a writing angle of 65° with a writing force of 1 N at a writing speed of 7 cm/s, in accordance with JIS S6037:2006. Further, by setting the bending stress of the pen tip 50 higher than the bending stress of the pen tip 20, it is possible to provide a writing instrument suitable for writing fine characters with the pen tip 50.

When a thermochromic ink is used as the ink for writing implements, a plastic elastomer whose erasing ability (erasure ratio) of pencil drawn lines defined by JIS S6050-2008 is lower than 70% is provided on the top of the cap 60 so as to form a low-wear rubbing body that can easily generate frictional heat by rubbing action, whereby it is possible to prevent spoiling the surroundings by reducing production of eraser dust during erasing.

As shown in FIGS. 2(a) and 2(b) and FIGS. 3(a) to 3(i), the pen tip 20 is formed of at least a writing core 30 having a writing part 25 and a holding body 40 having a viewer part. The writing core 30 having the writing part 25 is attached to the aftermentioned holding body 40 by adhesion, fusing, fitting or the like.

As shown in FIGS. 3(a) to 3(i), the writing core 30 of the present embodiment has an inclined (knife-cut) writing part 25 so as to produce an inclination for easy writing, and a pair of thin-plate pieces (sheet pieces) 31, 31 integrally extending from the ends of the writing part 25. It is formed in a substantially U-shaped (including a squared U-shape) configuration. The thin-plate pieces 31, 31 are formed to have a square cross-section.

The writing core 30 is not particularly limited as long as it efficiently feeds (supplies) the ink stored in the writing implement body 10 to the writing part 25 via the thin-plate pieces 31, 31, and may be composed of, for example, a liquid-permeable material such as fabric such as non-woven fabric, woven fabric, or knitted fabric, a liquid-permeable foam or a sintered body. The writing core 30 including the writing part 25 can be composed of one kind of material but can be configured by combining multiple materials by laminating. The writing part 25 and the other than the writing part 25 can be separately used and coupled or connected to each other.

In the present disclosure, the “nonwoven fabric” refers to a cloth-like structure in which one or more lumps of fibers are not knitted or woven. As the fiber material, synthetic fiber, natural fiber, animal hair fiber, inorganic fiber and the like are used. Examples of the synthetic fiber material used may include one kind, or combination of two or more kinds, of polyacetal resin, polyethylene resin, acrylic resin, polyester resin, polyamide resin, polyurethane resin, polyolefin resin, polyvinyl resin, polycarbonate resin, polyether resin, polyphenylene resin, and the like.

The fibers constituting the fabric material can be obtained by, for example, a melt spinning method, dry spinning method, wet spinning method, direct spinning method (melt blowing, spun bonding, electrostatic spinning, etc.), a method of extracting small-diametric fibers by suctioning one or more kinds of resin components from composite fibers, a method of beating fibers to obtain divided fibers, or any other known method.

The fibers constituting the fabric material may be composed of one kind or multiple kinds of resin components, and are generally called composite fibers: for example, Composite fibers of a core-sheath type, sea-island type, side-by-side type, orange type and the like can be used.

The fineness of the fibers constituting the fabric material is not particularly limited, but the fineness is preferably 0.1 to 500 dtex (deci-tex), and more preferably 2 to 5 dtex (deci-tex). Further, the fiber length is not particularly limited, but short fibers, long fibers or continuous fibers can be used.

When the fabric material is a woven fabric or knitted fabric, it can be prepared by weaving or knitting the fibers prepared as described above.

When the fabric material is a non-woven fabric, for example, a dry method, a wet method, or the like can be used as a method for preparing the fiber web capable of producing the non-woven fabric. Examples of methods of entangling and/or integrating the fibers constituting the fiber web into a non-woven fabric include a method of entangling the fibers by needles or water jets, a method of integrating the fibers with a binder, or a method of integrating the fibers with each other when the fiber web contains thermoplastic resin, by heat-treating the fiber web to fuse the thermoplastic resin. As the method for heat-treating the fiber web, for example, a method of heating and pressurizing with a calendar roll, a method of heating with a hot air dryer, a method of irradiating infrared rays under no pressure to fuse the thermoplastic resin fiber, and the like can be used. Further, a non-woven fabric may be prepared by collecting the fibers spun by the direct spinning method.

In a case of a liquid-permeable foam, it can be prepared by a known method, for example, by pouring a molten resin into a mold and foaming. In a case of a sintered body, plastic powders of polyacetal resin, polyethylene resin, acrylic resin, polyester resin, polyamide resin, polyurethane resin, polyolefin resin, polyvinyl resin, polycarbonate resin, polyether resin or polyphenylene resin can be sintered to form a porous body (sintered core) or the like.

The shape, thickness, and the like of the writing core 30 having the writing part 25 are designed considering a mounting aspect to the holding body 40, a shape of the writing part 25 and a maximizing of a view area of a viewer part 43 and an efficient discharge (supply) of ink to the writing part. Preferably the width and length specify the width and the length of the body and circumference of the attaching face of the following holding body 40 to which the thin-plate pieces 31, 31 of the writing core 30 are fixed, and are determined so as to let the ink efficiently flow to the writing part 25. Further, the thickness t of the thin-plate pieces 31, 31 other than the writing part 25 of the writing core 30 is preferably 0.3 to 3.0 mm, and most preferably 0.5 to 1.0 mm, from the viewpoint of maximizing the view area of the viewer part 43.

In the present embodiment, the writing part 25 is integrally formed with thin-plate pieces 31, 31 of the writing core 30 and is formed in an inclined shape (knife cut shape) so as to produce an inclination for easy writing. The inclination and the like are set for writing convenience as appropriate. Further, the writing part 25 is formed to produce a thick line width W of, preferably 1 mm or more, and more preferably, 2 mm or more.

The writing core 30 having the writing part 25 of this embodiment is integrally formed of a sintered core obtained by sintering plastic powders.

In the above embodiment, the writing part 25 and the thin-plate pieces 31, 31 are integrally formed of the same material, but the writing part 25 and the thin-plate pieces 31, 31 may be formed separately, and then coupled, joined, or abutted. The writing part 25 may be formed of, for example, a porous material having pores, and specific examples include sponge bodies, sintered bodies, and fiber bundle bodies, foams, sponges, felts, and porous bodies. Examples of the materials able to be used to form the porous body include natural fibers, animal hair fibers, polyacetal resin, polyethylene resin, acrylic resin, polyester resin, polyamide resin, polyurethane resin, polyolefin resin, polyvinyl resin, polycarbonate resin, polyether resin, polyphenylene resin and the like. Specifically, the writing part 25 may be formed of a sintered body obtained by sintering various plastic powders and the like while the thin-plate pieces 31, 31 are formed of, for example, a fabric material such as non-woven fabric, woven fabric or knitted fabric, or a material having liquid permeability such as a liquid-permeable foam.

As shown in FIGS. 3(a) to 3(i) and FIGS. 4(a) to 4(i), the holding body 40 fixes the above-described writing part 25 and the thin-plate pieces 31, 31 of the writing core 30, and is fixed to the front end opening of the front barrel 16 of the writing implement body 10, and is formed of a rounded main body 41, a flange 42 abutting on the endface of the writing implement body 10 and a viewer part (see-through part) 43 through which the writing direction can be observed, on the front side of the main body 41, and further has front holds 44a, 44b for holding the front end side (endface) of the writing part 25, formed on the front side of the viewer part 43.

The main body 41 further includes, in the rear side thereof, a rear retainer 45 continuously formed with the main body 41. In view of maximizing the view area of the viewer part 43, the holding body 40 thus formed of the above parts is formed with a structure arranged on the whole lengthwise outside peripheral surface so as to allow attachment (disposition) on the outer periphery of the holding body 40. Specifically, holding grooves 46, 46 for accommodating the thin-plate pieces 31, 31 of the above writing core 30 in a U-shape arrangement are formed on the whole lengthwise peripheral surface of the holding body 40. Further, the main body 41 has a concave fitting part 41a formed on the outer side surface along the circumferential direction thereof.

Further, in the holding body 40, the parts (thin-plate pieces 31, 31) of the writing core 30 in contact with the side surface of the holding body 40 are formed to have a square cross-section, and the outer peripheral edge of the viewer part 43, which is the front end of the holding body 40, is formed of beveled refracting facets 43a, 43a.

Forming the parts of the writing core 30 in contact with the side surface of the holding body 40 to have a square cross-section, makes it possible to enlarge the width of the viewer part 43 relative to the sectional area. Further, shaping the outer peripheral edge of the viewer part 43 of the holding body 40 into the beveled refracting facets 43a, 43a can make the square cross-section appear thin, whereby it is possible to make the area of the viewer part 43 appear still wider than before.

The whole holding body 40 thus configured is made of a hard material, for example, a hard material having see-through properties such as glass, resin having no rubber elasticity, or the like. Examples of resin having see-through properties with no rubber elasticity include PP, PE, PET, PEN, nylon (including general nylon such as 6 nylon and 12 nylon, and amorphous nylon) and acryl, polymethyl pentene, polystyrene, and ABS. Being formed by molding with the material having a visible light transmittance of 50% makes it possible to see through the viewer part 43 the characters written in the writing direction to be seen significantly. Note that only the viewer part 43 (including the beveled refracting facets 43a, 43a) may be formed of a material having see-through properties. Here, the visible light transmittance can be determined by measuring the reflectance with a multi-light source spectrocolorimeter (manufactured by Suga Test Instruments Co., Ltd., (MSC-5N)).

The holding body 40 may be made of one of the above materials, or may be made of two or more kinds of materials from the viewpoint of further improving durability and see-through properties, and can be molded by various molding methods such as injection molding, blow molding and the like.

The thin-plate pieces 31, 31 of the writing core 30 are fixed by adhesion with an adhesive, fusion or the like to the attachment surfaces 47 of the holding grooves 46 having a squared U-shape (or U-shape) in this holding body 40, thereby fixed to the writing part 25.

In the present embodiment, from the viewpoint of maximizing the view area of the viewer part 43, it is desirable that the thickness t of the thin-plate pieces 31, 31 is smaller than the thickness of the writing part 25, and the width (m) of the ink feeder is less than 90%, more preferably 50 to 80%, of the width (M) of the viewer part 43 of the holding body 40. Further, from the viewpoint of further enhancing the effect of the present disclosure, it is preferable that the aspect ratio of cross-section of the thin-plate pieces 31, 31 serving as the ink feeders, that is, the ratio of thickness t: width m (t:m), is 1:1.2 to less than 10, or more preferably 1:2 to less than 5.

In this writing implement A, for fixing (attachment) of the writing part 25 to the holding body 40, bonding with an adhesive or fusing may be additionally used in order to secure fitting and retention of the writing part 25 between the front holds 44a and 44b, and fixing (anti-falling) of the writing part 25.

As shown in FIGS. 1(a) and 1(b), the pen tip 50 is a rod-shaped tip of a fine type, and has a circular cross-section. The rear end (ink absorbent body side) of the pen tip 50 is inserted into the ink absorbent body 15 so that ink in the ink absorbent body is supplied to the pen tip 50 by capillarity.

The pen tip 50 is made of a porous material, and its examples include a parallel fiber bundle formed of one or a combination of natural fiber, animal fur fiber, polyacetal resin, polyethylene resin, acrylic resin, polyester resin, polyamide resin, polyurethane resin, polyolefin resin, polyvinyl resin, polycarbonate resin, polyether resin, polyphenylene resin, etc., a fiber core obtained by processing a fiber bundle such as felt or processing these fiber bundles with resin, a porous body (sintered core) obtained by sintering a plastic powder of thermoplastic resin as polyolefin resin, acrylic resin, polyester resin, polyamide resin, or polyurethane resin.

The pen tip 50 is preferably a fiber bundle core, a fiber core, a sintered core, a felt core, a sponge core, or an inorganic porous material core, and more preferably a fiber core from the viewpoint of deformation moldability and productivity. Also, the porosity, size, hardness, etc. of the pen tip 50 to be used vary depending on the type of ink, writing implement and others. The porosity is preferably set to 30 to 60%, for example. In the present disclosure, the “porosity” is calculated as follows. First, the writing core having a known mass and an apparent volume is dipped in water, and saturated with water, and then the mass is measured in a state of being taken out from the water. From the measured mass, the volume of water soaked up in the writing core is derived. Assuming the volume of water as the pore volume of the writing core, the porosity can be calculated from the following formula:

Porosity (unit:%)=(water volume)/(apparent volume of the pen tip 50)×100.

In the writing implement A thus configured, a twin-type writing implement A can be readily fabricated by inserting and holding the ink absorbent body 15 soaking up the ink into the writing implement body 10, fixing the pen tip 20 having the above configuration on the front side by fitting via the front barrel 16, and fixing the holding piece 55 having the pen tip 50 fixed therein on the other side by fitting. Ink soaked in the ink absorbent body 15 is efficiently supplied via the thin-plate pieces 31, 31 of the writing core 30 to the writing part 25 by capillary force in the pen tip 20, as well as to pen tip 50, and is available for writing.

With this writing implement A, since the pen tip 50 is the same as a conventional generic pen tip, the functions of the pen tip 20 will be described below.

As shown in FIGS. 1 and 2, the pen tip 20 of this writing implement A has the viewer part (window) 43 that allows visual recognition of the writing direction. By the capillary force of the thin-plate ink pieces 31, 31 of the writing core 30, ink in the ink absorbent body 15 reaches the writing part 25 and is available for writing. On the occasion of writing, as the user looks at the see-through side through the viewer part (window) 43, the user can easily place the starting position of drawing, and stop the pen tip at an exact point desired to stop at the end of drawing to prevent excessive drawing or overshoot.

In the present disclosure, the pen tip 20 is configured to feed ink from the ink absorbent body 15 to the writing part 25 through the thin-plate pieces 31, 31 of the writing core 30 that are thinner than the writing part 25 and has a good discharge. In addition, since the thin-plate pieces 31, 31 are made of a sheet-like porous material, the ink discharge is good, and it is not necessary to design the thin-plate pieces to be thick, so that the viewer part 43 is not shaded. By forming the part of the writing core 30 in contact with the side surface of the holding body 40 so as to have a square cross-section, the width of the viewer part 43 relative to the cross-sectional area can be enlarged. Further, the outer peripheral edges of the viewer part 43 of the holding body 40 are shaped in beveled refracting facets 43a, 43a, which makes the square cross-section look thin. As a result, when a line is drawn from left to right by a right-handed user, the user can draw a line by the writing part 25 while visually checking the writing direction through the viewer part 43. Further, maximizing the effective area of the viewer part relative to the whole pen tip and efficient supplying of ink to the integrally formed writing part 25 through the thin-plate pieces 31, 31 having the above-described features, make it possible to provide a writing implement that can offer excellent ink discharge and also maximize the effective area of the viewer part 43 without loss of ink discharge.

Also, since this writing implement A has a good ink discharge, even if the pen tip 20 is moved in a high speed during writing, ink supply follows well so that ink starving in a writing trace is prevented.

Since the writing implement of the present disclosure is characterized by including the pen tip 20 having the above configuration, the configurations other than the pen tip 20 are not particularly limited. Hereinafter, other embodiments of writing implements of the present disclosure will be described.

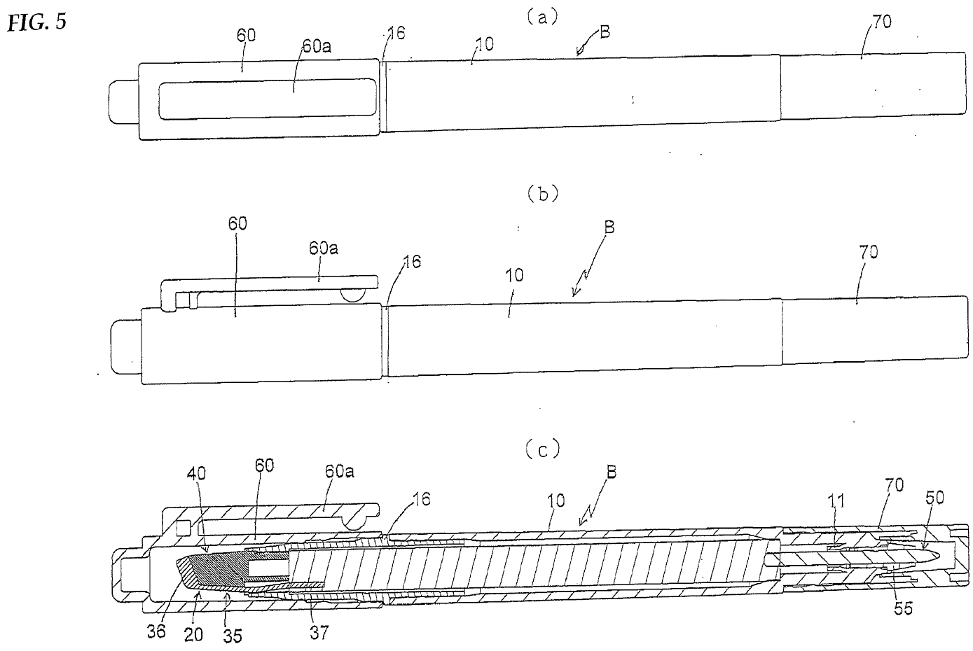

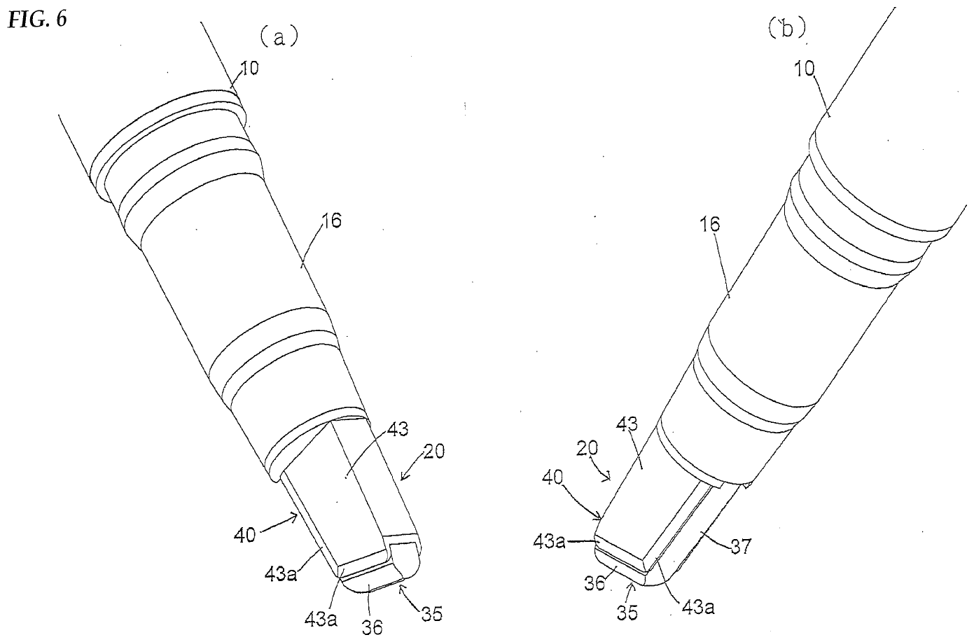

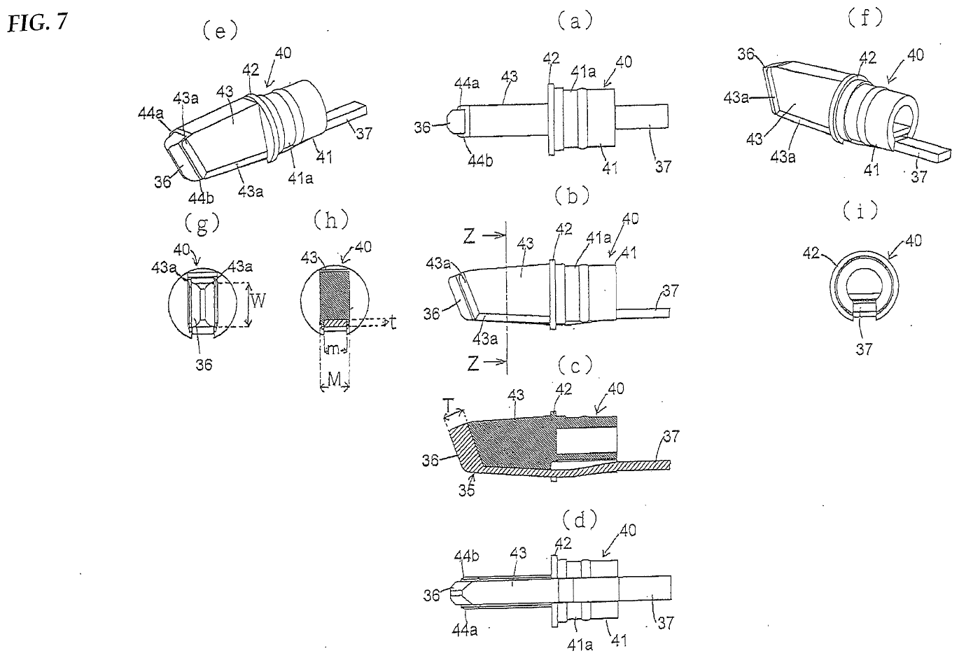

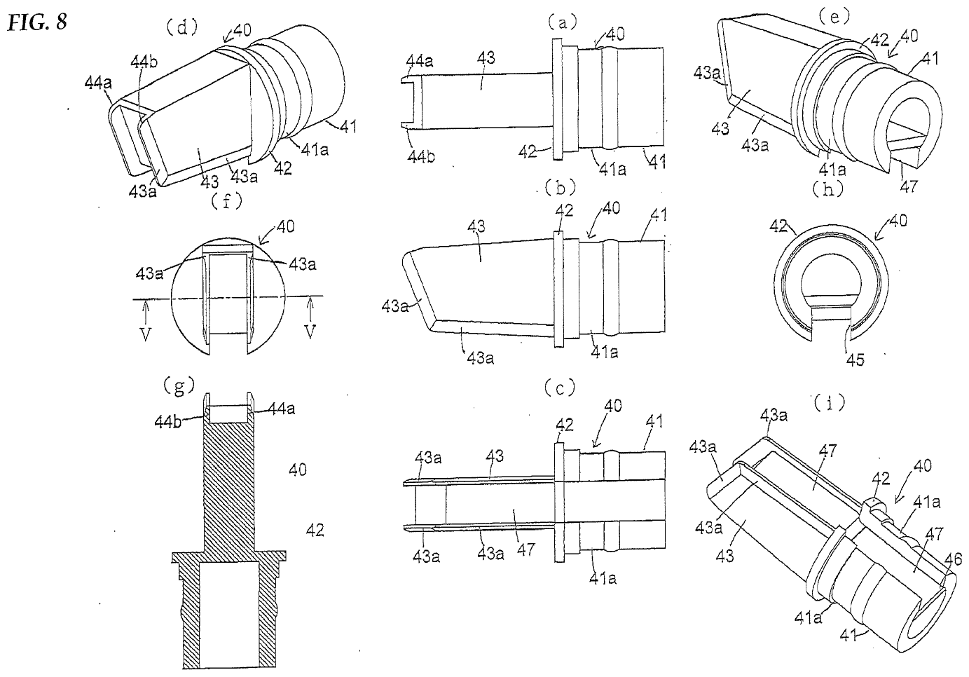

FIGS. 5 to 8 are drawings showing other examples of the embodiment of a pen tip 20 in the writing implement of a second embodiment of the present disclosure. When this writing implement has the same configuration and function with those of the above writing implement A of the embodiment, description on the components will be omitted by giving the same reference numerals in the drawings and the like in each of the following embodiments.

While the writing core 30 of the above embodiment is formed to have a U-shaped configuration, a writing implement B of the second embodiment differs in that, as shown in FIGS. 5 to 8, a writing core 35 having an L-shaped configuration is attached to the holding body 40.

A writing part 36 of the writing core 35 of the second embodiment has the same shape as the writing part of the above embodiment, and has an inclined shape (knife cut shape) so as to offer an inclination that makes it easy to write. In the writing core 35, a thin-plate piece 37 is integrally connected from an end side of the writing part 36, forming an L-shaped configuration and has a square shape in cross-section.

As shown in FIGS. 5 to 8, the holding body 40 fixes the writing part 36 and the thin-plate piece 37 of the writing core 35, and is fixed to the front end opening of the front barrel 16 of the writing implement body 10. In the embodiment of FIG. 1 above, the attachment surfaces 47 for attaching the thin-plate pieces 31, 31 are formed at upper and lower sides, but in the present embodiment, the writing core is formed in the L-shape, so that the writing core is attached only to the lower side of the holding body 40. Accordingly, like in the embodiment of FIG. 1, the holding body 40 is formed of a rounded main body 41, a flange 42 abutting on the endface of the writing implement body 10 and a viewer part (see-through part) 43 through which the writing direction can be seen, on the front side of the main body 41, and further has front holds 44a, 44b for holding the front end side (endface) of the writing part 36 on the front side of the viewer part 43.

On the bottom side in the rear of the main body 41, a rear retainer 45 continuously formed with the main body 41 is equipped. In view of maximizing the view area of the viewer part 43, on the whole bottom surface side of the holding body 40 thus formed of the above parts, a structure is attached (disposed) on the bottom surface of the holding body 40. Specifically, a holding groove 46 for accommodating the thin-plate piece 37 of the above writing core 35 in the L-shape arrangement is formed on the whole bottom surface of the holding body 40. Further, the main body 41 has a concave fitting part 41a formed on the outer peripheral side along the circumferential direction thereof, as in FIG. 1.

In the holding body 40, the part (thin-plate piece 37) of the writing core 35 in contact with the side surface of the holding body 40 is formed to have a square cross-section, and the outer peripheral edge of the viewer part 43, which is the front end of the holding body 40, is formed in beveled refracting facets 43a, 43a.

In this writing implement B, since the writing core 35 has an L-shaped configuration, the thin-plate piece 31 is not mounted on the upper side of the viewer part 43, differing from the U-shaped configuration in FIG. 1. Therefore, there is nothing to shade, so that the area of the viewer part can be expanded correspondingly. The part of the writing core 35 in contact with the side surface of the holding body 40 is formed to have a square cross-section, so that the width of the viewer part 43 relative to the sectional area can be expanded on the bottom side. Further, shaping the outer peripheral edge of the viewer part 43 of the holding body 40 into the beveled refracting facets 43a, 43a can make the square cross-section look thinner, whereby it is possible to make the area of the viewer part 43 appear wider than that of FIG. 1.

The pen tip 20 of the second embodiment is attached in the same manner as the writing implement of FIG. 1, has the viewer part (window) 43 that allows visual recognition of the writing direction. By the capillary force of the writing core 35, ink in the ink absorbent body 15 reaches the writing part 36 and is available for writing. On the occasion of writing, if the user looks at the see-through side through the viewer part (window) 43, the user can easily place the starting position of drawing, and stop the pen tip at an exact point desired to stop at the end of drawing to prevent excessive drawing or overshoot.

In the second embodiment, in the pen tip 20 the thin-plate piece 37 of the writing core 35 of discharge is thinner than the thickness of the writing part 35, and the ink is fed from the ink absorbent body 15 to the writing part 36 via the thin-plate piece 37. In addition, since the thin-plate piece 37 is made of a material having an ink supply capacity superior to that of the embodiment shown in FIG. 1, the ink discharge is good, it is not necessary to design the thin-plate piece to be thick, and the viewer part 43 is not shaded. By forming the part of the writing core 35 in contact with the side surface of the holding body 40 so as to have a square cross-section, the width of the viewer part 43 relative to the cross-sectional area can be enlarged. Further, the outer peripheral edges of the viewer part 43 of the holding body 40 are shaped in beveled refracting facets 43a, 43a, which makes the square cross-section look thin. As a result, when a line is drawn from left to right by a right-handed user, the user can draw a line by the writing part 36 while visually checking the writing direction through the viewer part 43. Further, maximizing the effective area of the viewer part relative to the whole pen tip, and efficient supplying of ink to the integrally formed writing part 36 through the thin-plate piece 37 having the above-described features, make it possible to provide a writing implement that can offer excellent ink discharge and also maximize the effective area of the viewer part 43 compared to the embodiment of FIG. 1, without loss of ink discharge.

Also, since this writing implement B has a good ink discharge, even if the pen tip 20 is moved at a high speed for writing, ink supply follows well so that ink starving in a writing trace is prevented.

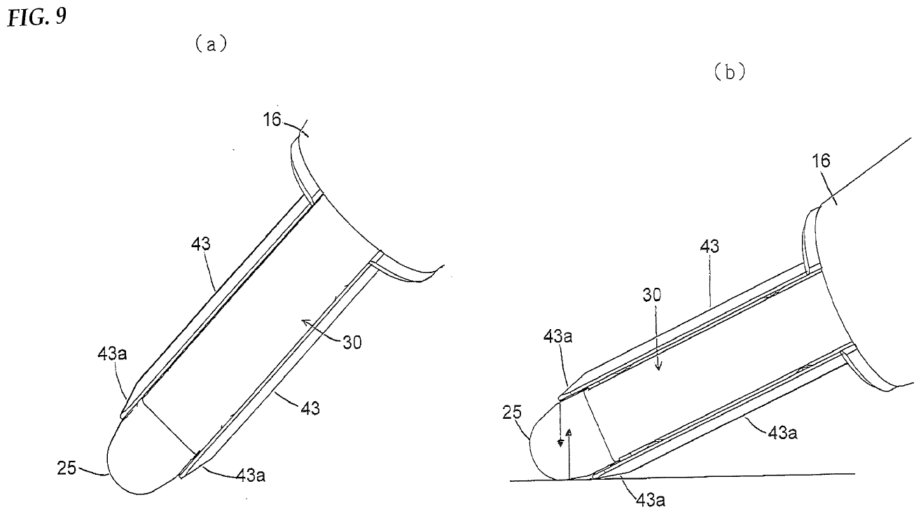

As shown in FIGS. 9(a) and 9(b), the pen tip shapes of the writing implement A of the first embodiment and the writing implement B of the second embodiment are preferably configured such that the heights of the guides on both sides of the writing core 30 are specified so as to create a compression relationship with the load applied from the writing surface when the pen tip is placed at the limit writing angle. This configuration brings even better strength.

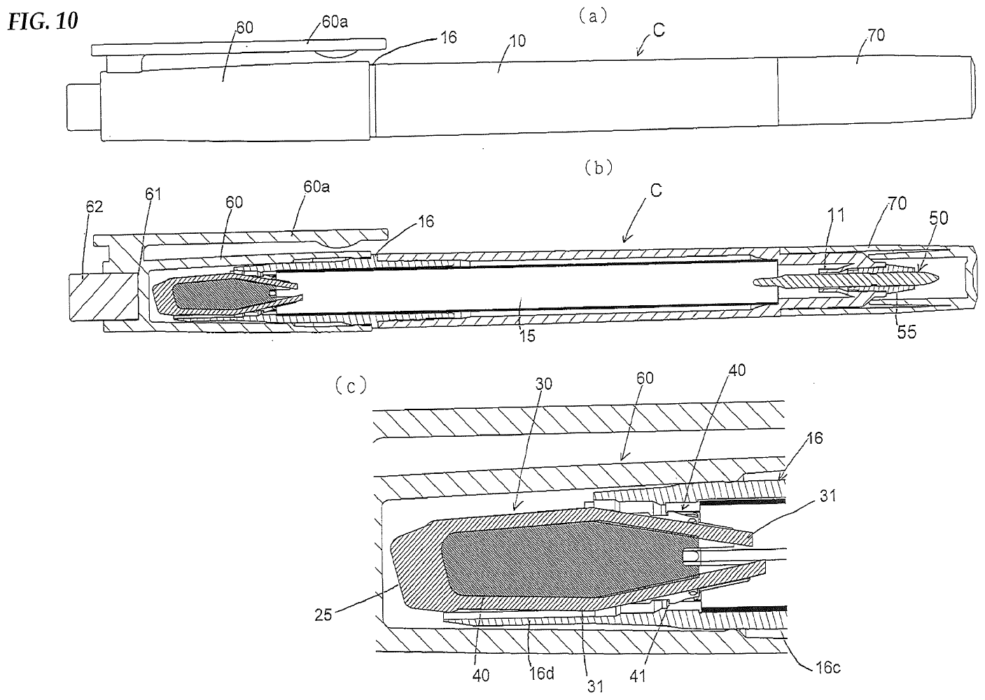

FIGS. 10 to 15 are drawings showing a writing implement according to a third embodiment of the present disclosure.

A writing implement C of the present embodiment differs from the writing implement A of the above embodiment in that the structures of the ink absorbent body 15, the front barrel 16, the writing core 30, the holding body 40, and the cap 60 are slightly different.

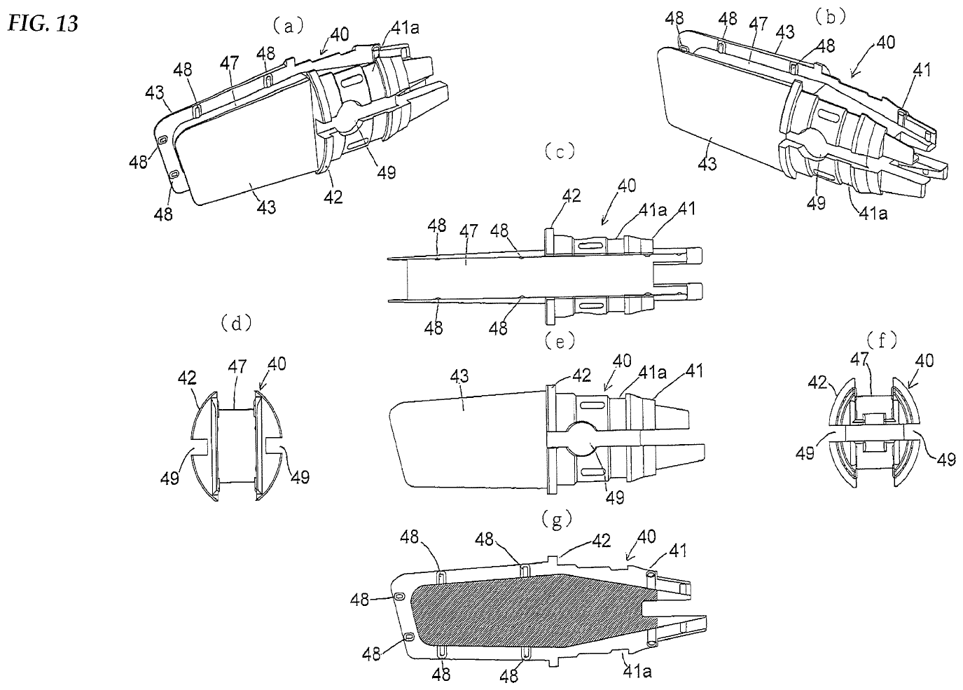

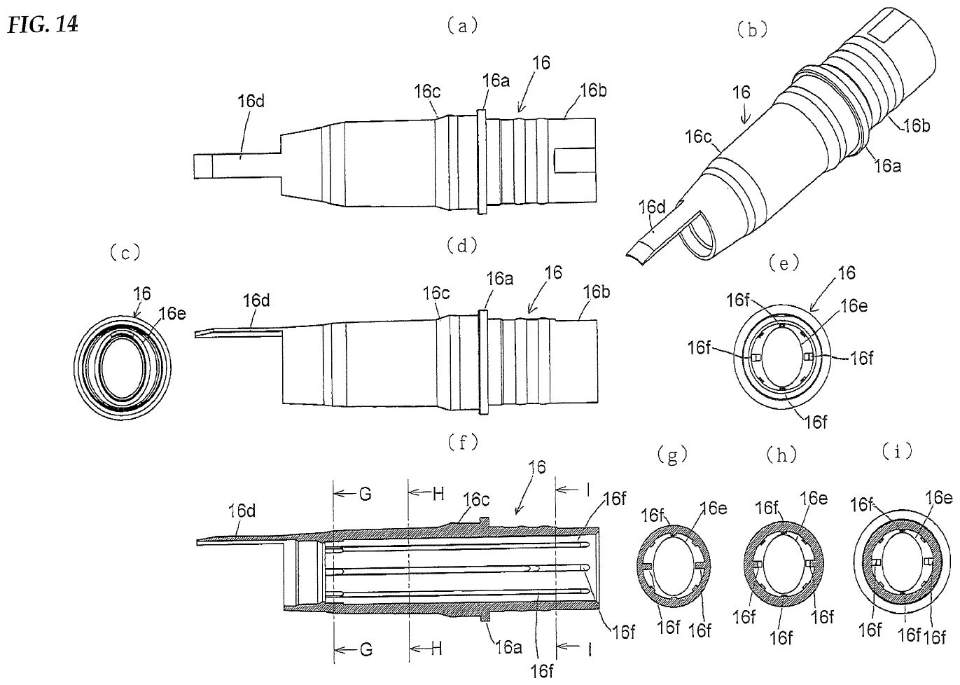

Specifically, the front barrel 16 is different from the writing implement A of the above embodiment in that as shown in FIGS. 14(a) to 14(i), it is composed of a circular cylindrical body, and including at least a flange part 16a arranged in the rear part of the center thereof, a rear part 16b having a fitting step on the rear side of the flange part 16a, a front part 16c having a fitting step on the front side, a covering piece 16d that is integrally formed at the front end of the front part 16c to cover at least part of the outer circumference of the writing core 30, and holding projections 16f, 16f . . . that are disposed at predetermined intervals on elliptical outer circumference 16e inside the cylindrical body to hold an elliptical ink absorbent body 15; that as shown in FIGS. 13(a) to 13(g), the holding body 40 has ribs 48, 48 . . . with which the writing core 30 is in contact formed at predetermined intervals on the surface thereof in the direction perpendicular to the axis, that it has air flow grooves 49, 49 with circular holes formed on the outer peripheral part on both lengthwise sides of the main body 41; that as shown in FIG. 10(c), the front barrel 16 and the holding body 40 are joined by arrowhead fitting; and that as shown in FIG. 10(b), a cap 60 has a frictional body 62 made of thermoplastic elastomer having an erasing ability (erasing ratio) of pencil drawing lines defined in JIS S 6050-2002 at less than 70% is fixed in a concave part 61 at the top.

The writing implement C thus configured has good ink discharge, and achieves maximization of the effective area of the viewer part 43 without impairing the ink discharge as well as the action and effect of the writing implement A. In addition, the slight differences in structure of the aforementioned ink absorbent body 15, the front barrel 16, the writing core 30, the holding body 40 and the cap 60 would further produce the following effects.

Since the outer shape of the ink absorbent body 15 is elliptical whilst the outer circumference 16e inside the front barrel 16 is formed with holding projections 16f, 16f . . . to hold the elliptical ink absorbent body 15, the ink absorbent body 15 is prevented from rotating. In addition, as shown in FIG. 10(c), the front barrel 16 and the holding body 40 are fixed to each other by arrowhead fitting, so that fixing of the holding body 40 with the writing core 30 attached to the writing implement is further enhanced, offering excellent durability.

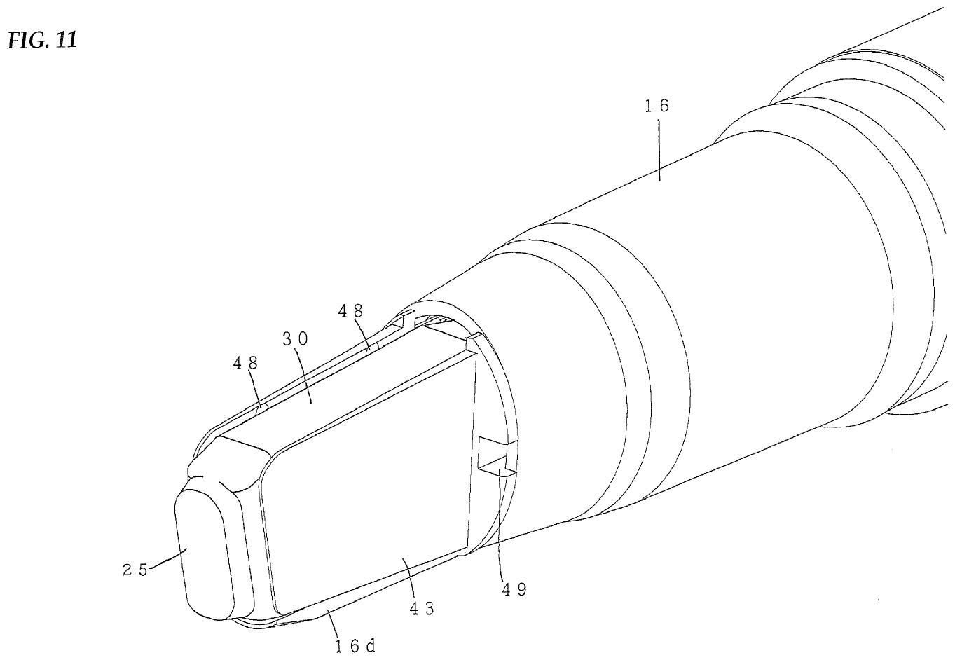

Since the covering piece 16d integrally provided at the front end of the front part 16c of the front barrel 16 covers one of the thin-plate pieces 31, as shown in FIGS. 10(c) and 11, the outer surface of the thin-plate piece 31 is protected. In addition, when a line is drawn with a ruler or the like, the ruler will not be soiled.

When the ink stored in the ink absorbent body 15 is a thermochromic ink, the drawn line or the like can be erased by a rubbing operation of a frictional body 62 that is attached at the top of the cap 60 and can easily generate frictional heat, while it produces less eraser dust during friction and hence prevents the surroundings from spoiling.

As shown in FIG. 13, the holding body 40 has ribs 48, 48 . . . , which are formed on the surface with which the writing core 30 comes into contact, at predetermined intervals, extending in the direction perpendicular to the axial line, so that it is possible to assemble the brittle legs and the like of the writing core 30, which undergoes dimensional variations due to a molding process, stably to the holding body 40. Further, even if the air pressure in the writing implement increases, ink leakage and the like can be eliminated by adjustment with the function of the air flow grooves 49, 49.

Further, in the writing implement C according to the third embodiment of the present disclosure, differing from the writing implement A of the first embodiment described above, even when the beveled refracting surfaces 43a and 43a are not provided on the outer peripheral edge of the viewer part 43 forming the front end of the holding body 40, it is possible to achieve maximization of the effective area of the viewer part 43 by only an arrangement in which the part of the writing core 30 in contact with the side surface of the holding body 40 is formed to have a square cross-section.

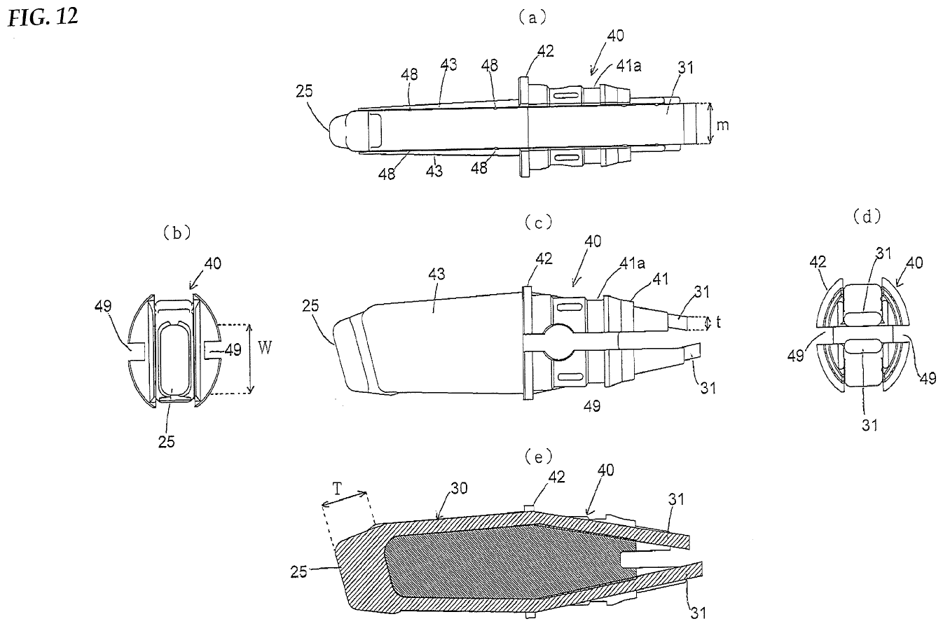

Further, by making the length of the rear ends of the holding body 40 different between the top and bottom, the distances of the writing core 30 having different lengths between the top and bottom as shown in FIG. 12, to the holding body 40 become equal to each other, so that it is possible to prevent bending of only one of the rear parts of the writing core 30 when the writing core 30 is put in contact with the sliver.

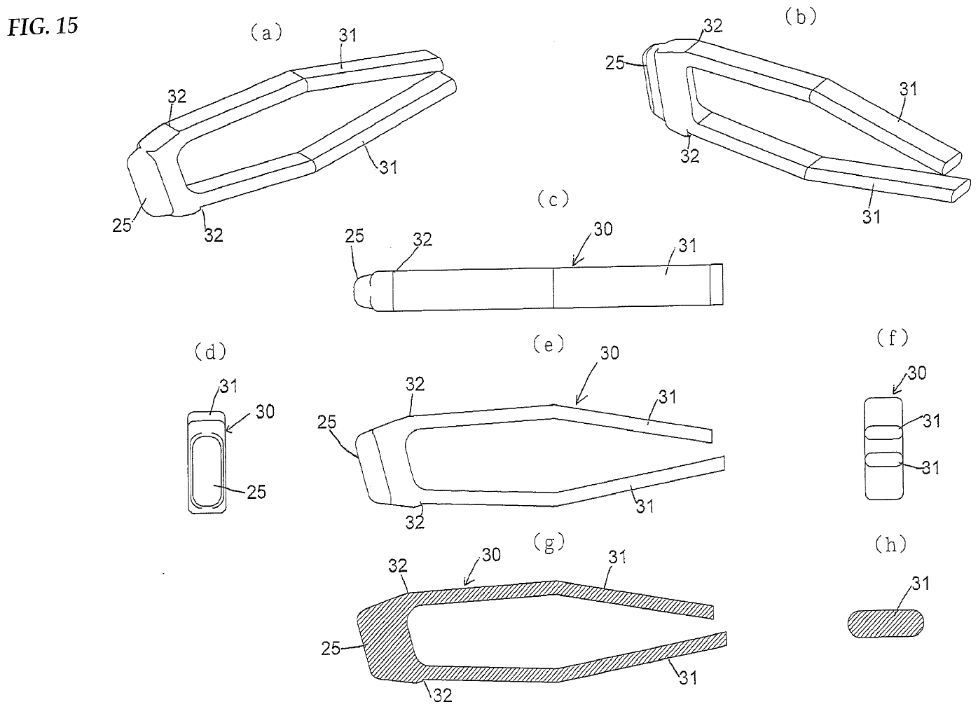

FIG. 15 shows drawings of the writing core 30 used in the writing implement C of the third embodiment.

As shown in FIGS. 15(a) to 15(b), the writing core 30 of this embodiment is the same as the writing core used in the writing implements A to C of the above embodiments in that it has an inclined (knife-cut) writing part 25 so as to produce an inclination for easy writing, further including thin-plate pieces (sheet pieces) 31, 31 integrally extending from the both ends of the writing part 25 to form a substantially U-shaped (including a squared U-shape) configuration, and the thin-plate pieces 31, 31 have a square cross-section. However, the present embodiment differs in that stepped parts 32, 32 are provided at the boundaries between the thin-plate pieces (sheet pieces) 31, 31 to be ink supplying parts and the writing part 25.

Further, the effective area of the viewer part 43 can be maximized by forming a flattened shape such as an elliptical cross-section.

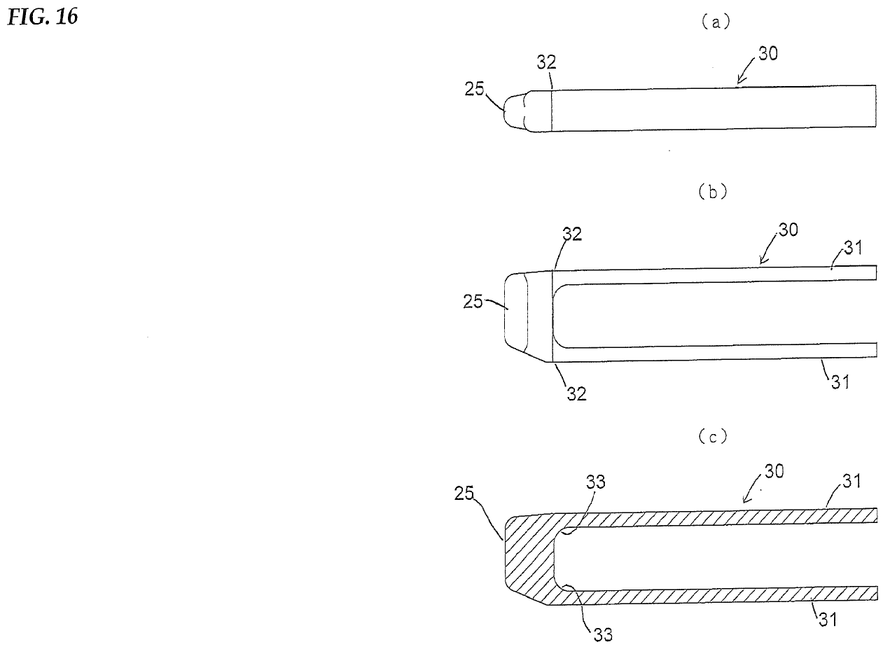

In the writing core 30, since, as shown in FIG. 16, the stepped parts 32, 32 are provided at the boundaries between the thin-plate pieces (sheet pieces) 31, 31 serving as the ink feeders, and the writing part 25, when the thin-plate pieces 31 are assembled after assembling the writing part 25 into the grooves. The side surface of the thin-plate piece 31 will not abut on the corner of the groove, hence assembly performance is improved.

Further, as shown in FIG. 16, it is also preferable that base parts 33, 33 inside the joints between the thin-plate pieces (sheet pieces) 31, 31 serving as the ink feeders and the writing part 25, are formed by round-surface shaping or bracket-surface shaping so as to further increase the strength of the base parts 33, 33.

The writing implement of the present disclosure is not limited to each of the above embodiments, and various modifications can be made as far as it does not change the technical idea of the present disclosure.

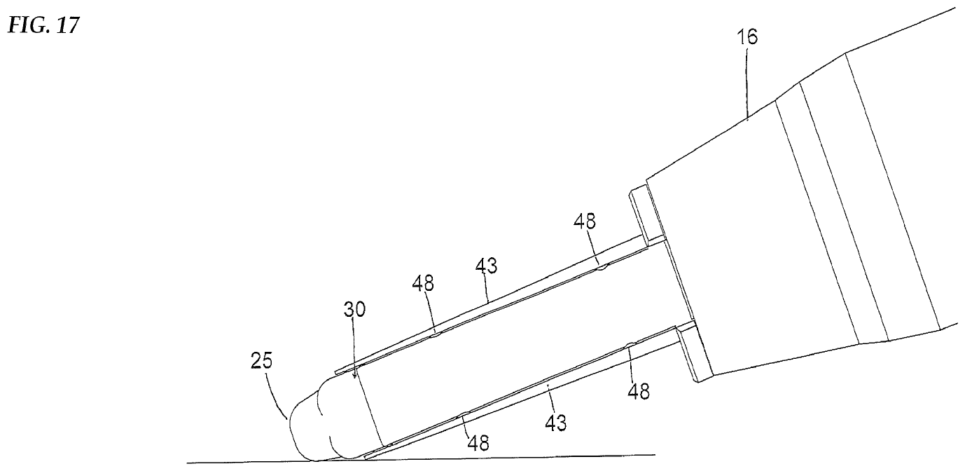

Further, as shown in FIG. 17, it is preferable that the shape of the pen tip is formed such that the line width is not subject to increase when the pen tip is inclined. When the writing tip is formed with such an originally rounded shape that the writing contact surface becomes shorter than the width, it is possible to prevent the contact width on the paper surface from extremely increasing depending on the writing angle in a case a line narrower than the pen tip is drawn.

Further, fastening between the holding body 40 and the writing core 30 may be done by fixing with fittings or the like, fixing with a hot melt type adhesive, fixing by solvent permeation, fixing by ultrasonic welding, and fixing with a reactive adhesive (moisture curing, UV curing, oxygen curing, two-part curing), fixing with a solvent-based adhesive (soluble synthetic resin, emulsion, rubber), fixing with a tape or double-sided tape.

The porosity of the writing core 30 is preferably specified to fall within the following range.

The porosity is preferably 30 to 80%, more preferably 40 to 70%. In the method of measuring the porosity, the apparent volume of pores is determined by the immersion method in water, and the porosity is determined as a value calculated by

(1−(the apparent volume of pores/the volume of writing core))×100 (%).

Though the above embodiments are of a twin-type writing implement, the pen tip 50 may be omitted (by forming the barrel body as a cylinder with a bottom) so as to provide a single-type writing implement having the pen tip 20. Also, the writing implement may be configured with the pen tip 20 of a click-type that is projected and retracted.

In each of the writing implements A to C of the above embodiments, the cross-section of the barrel body of the writing implement body is formed in a circular shape, but may be formed in a variant shape such as a triangular shape, a polygonal shape having four or more sides, or an elliptical shape. Also, the shown examples use the pen tip 20 whose entire body is formed of transparent material, but the pen tip 20 may be given as a two-color molding configured such that at least the viewer part 43 is formed of transparent material while the part on the main body 41 side attached in the main body of the writing implement may be formed of a resin material other than transparent material.

Further, in the description of each of the above embodiments, ink for writing implements (water-based ink, oil-based ink, thermochromic ink) is used, but liquid materials such as liquid cosmetics, liquid medicines, coating liquids, and correction liquids may be used.

### EXAMPLES

Next, the present disclosure will be described in more detail with reference to examples, but the present disclosure should not be limited to the following examples.

### Example 1

A writing implement having a pen tip conforming to a structure as follows and FIGS. 1 to 4 was used with an ink for writing implements having the following composition. The dimensions and the like of the pen tip used were these shown below.

### (Configuration of Pen Tip 20)

Made of acrylic resin, having a visible light transmittance of 85% [the visible light transmittance was obtained by measuring the reflectance with a multi-light source spectrocolorimeter (MSC-5N) manufactured by Suga Test Instruments Co., Ltd.]

Size of the viewer part (window) 43 (square): 9 mm×8 mm×5 mm×4 mm

Width M of the viewer part: 3.0 mm

Writing core 30: the composition of thin-plate pieces 31, 31: polyethylene sintered core, length m in the width direction: 2 mm, length in the longitudinal direction: 20 mm, thickness t: 0.5 mm, t:m=1:4, writing part 25: polyethylene sintered core, porosity: 50%, 4×3×6 mm, T=3 mm, W=5.5 mm

Ink absorbent body 15: PET fiber bundle, porosity 85%, φ6×77 mm

Writing implement body 10, cap 60, 70: made of polypropylene (PP)

Pen tip 50: polyester fiber bundle core, porosity 60%, φ2.0×40.0 mm

### (Ink Composition for Writing Implements: Ink Color: Fluorescent Yellow)

As the ink for writing implements, ink of the following composition (total 100% by mass) was used.

Moisturizer:
trimethylglycine (glycine betaine) 7.5% by mass,
pentaerythritol 4.5% by mass

Coloring agent: NKW-4805 yellow
(Nippon Keiko Kagaku Co., Ltd.) 40.0% by mass

Preservative: Bioace (KI Chemical Industry Co. Ltd.) 0.3% by mass

pH adjusting agent: triethanolamine 1.0% by mass

Fluorosurfactant: SURFLON 8111N
(AGC Seimi Chemical Co. Ltd.) 0 2% by mass

Water-soluble organic solvent:
ethylene glycol 3.0% by mass

Water (solvent): ion-exchanged water 43.5% by mass

Viscosity (25° C.): 3.0 mPa·s (cone/plate type viscometer, manufactured by TOKIMEC Co. Ltd., TV-20)

Surface tension (25° C.): 33 mN/m (automatic surface tension meter, manufactured by Kyowa Interface Science Co. Ltd., DY-300)

In the writing implement using the pen tip 20 of Example 1 conforming to FIGS. 1 to 4, ink is fed from the ink absorbent body 15 to the writing part 25 through the thin-plate pieces 31, 31 that are thinner than the thickness of the writing part 25 and has a good discharge. Further, since the writing core 30 including the writing part 25 and the thin-plate pieces 31, 31, has a U-shaped configuration and is formed of a sintered polyethylene core of the above configuration, the core offers a strong capillary force with respect to the porosity, further can be made extremely thin, and has a good ink discharge, so that it is not necessary to design the ink feeders to be thick, which will not hinder the viewer part 43. Moreover, the part of the writing core 30 in contact with the side surface of the holding body 40 is formed to have a square cross-section, whereby the width of the viewer part 43 with respect to the sectional area can be enlarged. In addition, the outer peripheral edge of the viewer part 43 of the holding body 40 is formed with beveled refracting facets 43a, 43a so as to make the square cross-section appear thin. As a result, a right-handed user can draw lines by the writing part 25 while visually checking the writing direction through the viewer part 43 when a line is drawn from left to right by the user. Further, the effective area of the viewer part relative to the entire pen tip can be maximized and ink can be efficiently supplied to the integrally formed writing part 25 through the thin-plate pieces 31, 31 having the above-described features. Thus, it could be confirmed to provide a writing implement that can maximize the effective area of the viewer part 43 and be excellent ink discharge without impairing the ink flow. It was also confirmed that even after dropping the writing implement from a height of 1 m, writing could be performed without ink starving.

Further, this writing implement was set in an automatic writing machine and tested in a method following JIS S6037:2006. After writing a line on a quality paper surface at a writing angle of 65° by applying a writing load of 1 N at a speed of 7 cm/s, the state of the drawn line was visually checked. As a result, with use of the above-described preferable ink composition, it was found that the pen tip 20 could produce fine ink flow (15 mg/m), and that excellency in dryability of the drawn line and low-temperature stability of ink was presented without causing blurring or strikethrough in the drawn line while suppressing drying of the pen tip.

### Example 2

A writing implement having a pen tip conforming to a structure as follows and FIGS. 5 to 8 was used with an ink for writing implements having the following composition. The dimensions of the pen tip used are shown below.

### (Configuration of Pen Tip 20)

The configuration of the writing implement is the same as that of the above embodiment except in that the writing core 35 is specified as follows, so that its description is omitted.

The writing implement body 10, ink absorbent body 15, holding body 40, ink composition and others: the same as or conforming to those in the above Example 1.

Size of the viewer part (window) 43 (square): 9 mm×8 mm×5.2 mm×4.2 mm

Width M of the viewer part: 3.0 mm

Writing core 35: the composition of thin-plate piece 37: polyethylene sintered core, length m in the width direction: 2 mm, length in the longitudinal direction: 20 mm, thickness t: 0.8 mm, t:m=1:2.5, writing part 36: polyethylene sintered core, porosity: 50%, 4×3×6 mm, T=3 mm, W=5.5 mm

In the writing implement using the pen tip 20 of the Example 2 conforming to FIGS. 5 to 8, ink is fed from the ink absorbent body 15 to the writing part 36 through the thin-plate piece 37 that is thinner than the thickness of the writing part 36 and has a good discharge. Further, since the writing core 35 including the writing part 36 and the thin-plate piece 37, has an L-shaped outer circumferential edge of the viewer part 43 of the holding body 40 is formed in beveled refracting facets 43a, 43a so as to make the square cross-section appear thin. As a result, a right-handed user can draw lines by the writing part 36 while visually checking the writing direction through the viewer part 43 when a line is drawn from left to right by the user. Further, the effective area of the viewer part relative to the entire pen tip can be maximized more than the above Example 1, and ink can be efficiently supplied to the integrally formed writing part 36 through the thin-plate piece 37 having the above-described features. Thus, it could be confirmed to provide a writing implement that can maximize the effective area of the viewer part 43 and be excellent in ink discharge without impairing the ink flow. It was also confirmed that even after dropping the writing implement from a height of 1 m, writing could be performed without ink starving.

Also, in this embodiment, ink discharge is good, so that even if the pen tip 20 is moved in a high speed during writing, ink supply can follow well, hence it is possible to provide a writing implement with which no ink starving in writing trace will occur.

Further, this writing implement was set in an automatic writing machine and tested in a method following JIS S6037:2006. After writing a line on a quality paper surface at a writing angle of 65° by applying a writing load of 1 N at a speed of 7 cm/s, the state of the drawn line was visually checked. As a result, with use of the above-described preferable ink composition, it was found that the pen tip 20 could produce fine ink flow (15 mg/m), and that excellency in dryability of the drawn line and low-temperature stability was presented without causing blurring or strikethrough in the drawn line while suppressing drying of the pen tip.

### INDUSTRIAL APPLICABILITY

The pen tip of the present disclosure can be suitably applied to writing implements of types called underline pens, paint markers, oil-based markers, and water-based markers.

### DESCRIPTION OF REFERENCE NUMERALS

10 writing implement body
20 pen tip
25 writing part
30 writing core
40 holding body
43 viewer part

1. A writing implement equipped with a pen tip that feeds ink from a writing implement body and has a viewer part through which the writing direction can be recognized, wherein the pen tip comprises a holding body having the viewer part and a writing part having a writing core of U-shaped or L-shaped configuration fixed to the holding body,
wherein a part of the writing core in contact with a side surface of the holding body is formed to have a square cross-section.

2. The writing implement of claim 1, wherein a front end part of the holding body is formed in a folding facet.

3. The writing implement of claim 1, wherein a surface of the holding body with which the writing core is in contact is formed with ribs that extend in the direction perpendicular to the axis.

4. The writing implement of claim 2, wherein a surface of the holding body with which the writing core is in contact is formed with ribs that extend in the direction perpendicular to the axis.

5. The writing implement claim 1, wherein the aspect ratio of the cross-section of the supplying part in the writing core is 1:1.2 or greater.

6. The writing implement of claim 2, wherein the aspect ratio of the cross-section of the supplying part in the writing core is 1:1.2 or greater.

7. The writing implement of claim 3, wherein the aspect ratio of the cross-section of the supplying part in the writing core is 1:1.2 or greater.

8. The writing implement of claim 4, wherein the aspect ratio of the cross-section of the supplying part in the writing core is 1:1.2 or greater.

9. The writing implement of claim 1, wherein a front barrel that fixes the pen tip covers at least a part of an outer circumference of the writing core.

10. The writing implement of claim 2, wherein a front barrel that fixes the pen tip covers at least a part of an outer circumference of the writing core.

11. The writing implement of claim 3, wherein a front barrel that fixes the pen tip covers at least a part of an outer circumference of the writing core.

12. The writing implement of claim 4, wherein a front barrel that fixes the pen tip covers at least a part of an outer circumference of the writing core.

13. The writing implement of claim 5, wherein a front barrel that fixes the pen tip covers at least a part of an outer circumference of the writing core.

14. The writing implement of claim 6, wherein a front barrel that fixes the pen tip covers at least a part of an outer circumference of the writing core.

15. The writing implement of claim 7, wherein a front barrel that fixes the pen tip covers at least a part of an outer circumference of the writing core.

16. The writing implement of claim 8, wherein a front barrel that fixes the pen tip covers at least a part of an outer circumference of the writing core.
